(19) United States
(12) Patent Application Publication
(10) Pub. No.: US 2025/0347933 A1
(43) Pub. Date: Nov. 13, 2025

(54) SMART GLASSES FRAME, SMART GLASSES AND GLASSES LENS, AND METHOD FOR ASSEMBLING SMART GLASSES

(71) Applicant: tooz technologies GmbH, Aalen (DE)

(72) Inventors: Michael POLLMANN, Koenigsbronn (DE); Frank-Oliver KARUTZ, Blaustein (DE); Georg MICHELS, Aalen (DE)

(21) Appl. No.: 18/870,535

(22) PCT Filed: Feb. 28, 2023
(86) PCT No.: PCT/EP2023/054947

§ 371 Date: Nov. 29, 2024

(30) Foreign Application Priority Data
May 30, 2022 (DE) 10 2022 113 531.4

(51) Int. Cl. G02C 9/00; G02C 13/00

(52) U.S. Cl. CPC G02C 9/00; G02C 13/001

(57) ABSTRACT

A smart glasses frame for smart glasses includes a glasses frame designed to hold and position an exchangeable glasses lens; a display, connected to the glasses frame, designed to generate a virtual image; and glasses frame guidance elements designed to position and orient the display with respect to the glasses lens. Also provided are a glasses lens for smart glasses, smart glasses, a part set for obtaining smart glasses and a method for assembling smart glasses.

### PRIORITY

This application claims the benefit of German Patent Application No. 10 2022 113 531.4 filed on May 30, 2022, which is hereby incorporated herein by reference in its entirety.

### FIELD

The invention relates to a smartglasses frame for a pair of smartglasses, a lens for a pair of smartglasses, a pair of smartglasses, a kit of parts for obtaining a pair of smartglasses and a method for assembling a pair of smartglasses.

### BACKGROUND

Smartglasses are a newly arising segment of entertainment electronics, inter alia, in which two-dimensional image information is provided on the retina of the human eye.

A piece of image information on the retina can be generated in many different ways. Both scanning and non-scanning systems are conventional. In scanning systems, the perceived image is generated by virtue of both the pose and the strength of a quasi-punctiform intensity distribution on the retina being modulated in time. An example of a scanning system is described in WO 2014/155288 A2. In non-scanning systems, the pixel of an extended display are imaged simultaneously onto the retina.

It is often desirable to admit the undisturbed view of the surroundings in addition to the provision of an additional image information item (see-through wearables). In this case, the image information can preferably be displayed in the peripheral field of view of the user. This requirement prevents solutions in which a non-transparent image generator and an associated imaging optical unit are arranged directly in front of the eye. Therefore, the image information is usually generated outside of the field of view of the eye, and the generated image is reflected in the desired viewing direction in front of the eye with the aid of an optical unit.

Typical smartglasses, as described for example in DE 10 2011 007 812 A1 and US 2012/0002294 A1, to this end comprise an image generator for creating an image, also referred to as display below, and a lens, into which an imaging beam path emanating from the image generator is input coupled.

The image created by the display is input coupled into an optical waveguide, reflected one or more times within the optical waveguide by means of total internal reflection, and finally output coupled in the direction of the user's eye by means of an output coupling region present in the lens, with the result that the user of the smartglasses can see a virtual image. The spatial region from which the virtual image is visually perceivable by the user's eye is also referred to as an eye box.

In this case, the imaging beam path is output coupled in the direction of the eye by means of a beam-splitting output coupling region such that the virtual image is overlaid on the image of the surroundings, whereby the user perceives the virtual image in addition to the surroundings. An example of a pair of smartglasses in which the imaging beam path is guided by means of total internal reflection to an output coupling structure in the lens is described in DE 10 2013 223 963 A1 and DE 10 2013 223 964 B3, for example.

To enable always sufficiently accurate positioning of the display and the lens relative to one another, it is conventional practice in state-of-the-art smartglasses to adhesively bond the components together in order to establish a permanent secure connection. For example, in this regard, the display is adhesively bonded to a display holder, and this display holder is connected in turn to the lens by way of an adhesive connection.

If they provide any corrective effect at all, currently available smartglasses provide only for a limited corrective effect in accordance with the personal needs of the user; i.e., either smartglasses do not enable any visual correction at all, or visual correction is only possible by attaching add-ons, for example in the form of attachments, and this is found to be difficult to manage and esthetically unpleasing, and frequently connected to insufficient comfort of wear. Moreover, smartglasses generally also do not provide any, or only limited, UV protection and do not have any, or only limited, lens tint, and do not enable individualization of these properties either.

Moreover, users expect a pair of smartglasses to look like a normal pair of glasses and, as entertainment electronics equipment, be able to be purchased via the normal online and retail channels in the electronics sector. However, expertise available there in relation to an individual visual correction must be classified as low, and so an individual adaptation of the smartglasses to the personal visual correction needs of the user would be impossible or would only be possible to a insufficient extent. Consequently, in addition, an inclusion of opticians and/or ophthalmologists would be required for the individual visual correction prescription, which is often only insufficiently feasible given constraints of time and location.

In summary, one or more of the following disadvantages are associated with the existing solutions:
Smartglasses do not allow an individual visual correction, do not allow an individual lens tint and do not provide individual UV protection;
Smartglasses require an add-on in the form of a “prescription clip” in the glasses interior for the visual correction; this makes them heavier and appear cumbersome;
Depending on the technological concept used, smartglasses require a complex scan and adaptation process for the individual user which requires up to 2 hours' time of interaction in a store; subsequently, an individual lens is produced, which also requires much time, and finally the user must return to the store for a final adaptation, which may fail and requires a restart of the described process.

### SUMMARY

An object herein is to specify a pair of glasses and components for smartglasses, and a method for assembling a pair of smartglasses, which allow an individualization of the lens, for example for the individual visual correction, in a simple manner. By preference, the complexity with regards to adapting the smartglasses to the user should approximately correspond to the complexity with regards to adapting a normal pair of glasses.

A pair of smartglasses have lenses that are is easily replaceable, i.e. for example also by persons without specialist training, and can be replaced by an individually adapted lens, for example a lens adapted to the given visual acuity. The display and optionally present further optical elements continue to be used and remain in the assembled state during the replacement of the lens. To enable this, the display is not securely connected to the lens, contrary to what was conventional to date.

For example, the display can be or have been fastened in position-variable fashion to the glasses frame by way of a holder, while the lens is or has been inserted into the frame. The positioning of the lens relative to the display can be ensured by means of guide elements, for example by way of guide/alignment pins. This enables a predetermined positioning and alignment of lens and display when the frame is closed.

A smartglasses frame for a pair of smartglasses, i.e. a pair of smartglasses can be manufactured using the smartglasses frame. The smartglasses frame comprises a glasses frame designed to hold and position an interchangeable lens. Naturally, the glasses frame can also be designed to hold and position a plurality of lenses, especially two lenses.

Interchangeable lens means that the lens can be removed from the smartglasses frame non-destructively in relation to both the lens and the smartglasses frame and can be replaced by another lens, for example with a different visual correction. In relation to a more detailed explanation of the lens, reference is made to the statements given below.

To this end, the glasses frame can partly or fully enclose the lens or the lenses, as conventional in the art, wherein the framing pieces are interconnected by means of a centrally arranged bridge, i.e. in a manner connecting the nasal sides of the framing pieces, so that the glasses frame can be supported on the nose of a human observer, with the result that a positioning of the lenses in front of the human eye is made possible.

Sidepieces may be arranged on the temporal sides of the glasses frame in order to allow support on the ears of the human observer, i.e. a user. Other ways of fastening the glasses frame to the head of the user are also possible. The sidepieces can be connected to the glasses frame by means of a hinge in order to allow the sidepieces to be folded towards and away from the glasses frame for space-saving and secure storage. For example, the glasses frame can comprise a plastics material or consist of a plastics material since the latter is distinguished by a low weight with, at the same time, many different design options.

The smartglasses frame also comprises a display that is mechanically connected to the glasses frame. The display serves as image generator for the creation of the virtual image. For example, the display can be arranged directly on the glasses frame. Alternatively, an arrangement on or in the hinge of the sidepiece or an arrangement in the sidepiece itself is also possible, with the result that the display is connected to the glasses frame via the hinge or the sidepiece in these cases.

A display holder designed to receive the display and in turn connected to the glasses frame, e.g. to a display holder mount arranged on the glasses frame, can be provided for connecting the display to the glasses frame.

Moreover, the smartglasses frame comprises glasses frame guide elements designed to position and align the display with respect to the lens.

For example, the glasses frame guide elements can be designed as alignment or guide pins, for example with a cylindrical shape, or as a corresponding mating piece, i.e. as depressions accommodating alignment or guide pins. The combination of alignment or guide pins and accommodating depressions or a (partly) different embodiment of the glasses frame guide elements, e.g. as ribs or protrusions, is also possible. The precise geometric embodiment of the guide elements is determined by the geometric conditions and the structure of the smartglasses frame and the lens to be inserted therein.

To also allow an alignment of the display in addition to the positioning thereof and for example prevent the display from twisting vis-à-vis the lens, provision is made of at least two glasses frame guide elements which can be combined with one another as desired, e.g. in the form of a cylindrical guide pin with a guide rib arranged thereon, in order to ensure a specific alignment of the guide pin in an accommodating depression. By preference, the at least two glasses frame guide elements should be arranged as far from one another as possible in order to enable a positioning and alignment of the display vis-à-vis the lens which are as accurate as possible.

The term “glasses frame guide element” means that the guide element is part of the smartglasses frame, in contrast to the “lens guide element” described below, which is part of the lens. Consequently, the glasses frame guide elements can be arranged on the glasses frame, on the display and/or on the display holder, for example.

The glasses frame guide elements serve for an exact positioning and alignment of the display vis-à-vis the lens. This allows a simple and non-destructive exchange of the lens, for example by an optician or the user themselves. This allows smartglasses with different lenses to be obtained, for example allowing an individual visual correction, individual position of the eye box depending on the pupil position of the user, UV protection, tinting, etc. For example, only the replacement of the lens is required if a different visual correction is desired; the display always remains connected to the glasses frame in the meantime. In other words, further use can be made of the smartglasses frame with the display, and so it is possible to save costs and material for a newly made article otherwise required. A pair of smartglasses with in particular an individual, i.e. user-specific, visual correction can easily be obtained without the need to purchase a separate new pair of smartglasses and without the need for uncomfortable and ugly add-ons to provide the visual correction.

The option of simply replacing the lens can also contribute to opening up new sales channels for smartglasses. For instance, there is the option of selecting and optionally trialing the smartglasses frame, optionally with a lens without visual correction, in a store, at an optician or online. Subsequently, a replacement lens, for example with individual visual correction, individual eye box position, UV protection and/or tinting, is manufactured on the basis of the personal needs of the user and is inserted into the smartglasses frame by the user themselves or an optician or replaced by the previously present lens.

By preference, the display can be connected to the glasses frame in position-variable fashion. This means that the display can be moved vis-à-vis the glasses frame within tight boundaries. The movement can be enabled laterally, i.e. substantially in the plane of the glasses frame, and/or substantially perpendicular to the plane of the glasses frame. For example, a floating mount of the display can be realized vis-à-vis the glasses frame. For example, a lateral movement can be enabled by a dimensioning of guide elements for the connection of display and glasses frame with a specifiable play.

As a result, the lens can be exchanged within certain tolerances without impairing the required accurate positioning of display and lens to one another. This enables a simpler exchange of the lens.

Elastically deformable elements, e.g. in the form of foam elements, can be arranged between the display and the glasses frame for the purpose of forming the position-variable connection between display and glasses frame.

Such elastically deformable elements can be compressed and relaxed, with the result that, on the one hand, the distance between display and glasses frame is variable and, on the other hand, this does not result in an unwanted movement. The elastically deformable elements can preferably enable a movement of the display with respect to the glasses frame substantially perpendicular to the plane of the glasses frame.

The glasses frame can be designed in multiple parts according to various embodiment variants.

For example, the glasses frame can have a front frame part and a back frame part with a complementary design to the front frame part.

This means that the front frame part and the back frame part complement one another and can be assembled and connected, for example by way of click-in connections, screwed connections, or the like, to one another in order to form the glasses frame.

The two-part embodiment of the glasses frame enables a simple and safe replacement of the lens by virtue of the front and the back frame part being separated from one another and being reconnected to one another following the replacement of the lens.

Furthermore, the display can also be positioned between the front and back frame part and can be connected to the glasses frame. For example, the display held in the display holder can be inserted into one of the two frame parts, e.g. the back frame part, and can be screwed thereto. This enables a protected arrangement of the display, with the result that damage to the display, e.g. in the event of the smartglasses falling, can be avoided.

A further option for a multi-part design of the glasses frame may consist of the glasses frame having an upper frame part and a lower frame part which are connectable to one another and detachable from one another in the nasal region and/or in the temporal region, for example, with the result that accordingly the lens and/or the display can be inserted into the glasses frame or can be connected to the glasses frame in the case of the aforementioned variant with a front and a back frame part. In so doing, the lens or the display, optionally together with the display holder, can be inserted into the glasses frame with play and can subsequently be re-locked by connecting the frame parts. While the lens can be locked in a fixed position, the display can preferably be locked in position-variable fashion, as already described.

Alternatively, the glasses frame can be designed in one part, for example in one part and rigid or in one part and flexible.

In the case of a design which is rigid in one piece, the lens can be inserted into the glasses frame for example by virtue of the lens being placed against the glasses frame at the temporal side and then being pressed in the nasal direction into the frame under a slight rotation, with lens guide elements arranged on the lens being inserted into the glasses frame guide elements during this rotational movement.

In the case of a one-part design of the glasses frame, the display can be inserted into the glasses frame, for example from the back, and can be fastened, optionally fastened in position-variable fashion.

A one-part design of the glasses frame has the advantage of a simpler manufacturing process. Moreover, the stability can be increased vis-à-vis a multi-part embodiment because this manages without connecting points between a plurality of frame parts.

A design, which is flexible in one piece, of the glasses frame may provide the option of opening and re-closing the glasses frame, for example in the nasal and/or temporal region. In the case of a suitably flexibly designed glasses frame, the latter then can be deformed in such a way that the lens and/or the display can be inserted into the glasses frame and can be fastened by closing the glasses frame.

Also disclosed is an interchangeable lens for a pair of smartglasses. The lens comprises a lens shell, an optical waveguide designed to guide a light path for a virtual image, and lens guide elements designed to position and align the lens in relation to a display of a smartglasses frame.

In particular, the lens can be combined with a smartglasses frame according to the description above, i.e. the display of a smartglasses frame can be the display of the above-described smartglasses frame. In this respect, reference is made to the explanations given above. The advantages of the smartglasses frame are correspondingly associated with the lens.

For example, the lens shell can be a corrective lens, i.e. a lens shell designed to correct a visual error or for visual acuity correction. In an alternative to that or in addition, the lens shell may provide UV protection and/or have a tint, for example. Other individual designs, e.g. adapting the eye box position to the pupil position of the eye looking through the lens with optical an waveguide, are also possible, i.e. the lens shell can specify the position of the eye box. For example, the pupil position can be ascertained on the basis of the pupillary distance between right eye and left eye and/or as monocular pupillary distance from the center of the nosepiece of the glasses frame for one eye.

The lens shell is not limited to a specific geometric shape and may comprise for example a plastics material or glass, optionally with one or more coatings. The lens shell may also have a multi-part structure.

The lens shell may comprise an input coupling region for input coupling an image created by the display into the optical waveguide. Moreover, the lens shell may comprise an output coupling region with an output coupling structure in order to output couple an image, created by the display and reflected within the optical waveguide, in the direction of the eye of the user when the lens is used. For example, known input and output coupling structures can be used to this end, i.e. the invention is not limited to a specific input or output coupling structure.

In addition to the lens shell, the lens comprises an optical waveguide which steers the light path for a virtual image, i.e. guides an image created by the display to the output coupling structure by means of total internal reflection when the lens is used. The optical waveguide can also be referred to simply as waveguide.

Moreover, the lens comprises lens guide elements. These are designed to position and align the lens in relation to the display and therefore have, in particular, a complementary design to the glasses frame guide elements described above.

For example, the lens guide elements can be designed as alignment or guide pins, for example with a cylindrical shape, or as a corresponding mating piece, i.e. as depressions accommodating alignment or guiding pins. The combination of alignment or guide pins and accommodating depressions or a (partly) different embodiment of the lens guide elements, e.g. as ribs or protrusions, is also possible. The precise geometric embodiment of the guide elements is determined by the geometric conditions and the structure of the lens and the smartglasses frame, into which the lens should be inserted.

To also allow an alignment of the lens in addition to the positioning thereof and for example prevent the lens from twisting, provision is made of at least two lens guide elements which can be combined with one another as desired, e.g. in the form of a cylindrical guide pin with a guide rib arranged thereon, in order to ensure a specific alignment of the guide pin in an accommodating depression. By preference, the at least two lens guide elements should be arranged as far from one another as possible in order to enable a positioning and alignment of the lens vis-à-vis the display which are as accurate as possible.

The lens guide elements serve for an exact positioning and alignment of the lens vis-à-vis the display. This allows a simple and non-destructive exchange of the lens, for example by an optician or the user themselves. This allows smartglasses with different lenses to be obtained, for example allowing an individual visual correction, an adaptation to the individual pupil position, UV protection, tinting, etc. For example, only the replacement of the lens is required if a different visual correction is desired; the display always remains connected to the glasses frame in the meantime. In other words, further use can be made of the smartglasses frame with the display, and so it is possible to save costs and material for a newly made article otherwise required. A pair of smartglasses with in particular an individual, i.e. user-specific, visual correction can easily be obtained without the need to purchase a separate new pair of smartglasses and without the need for uncomfortable and ugly add-ons to provide the visual correction.

The individualized lens, for example with visual correction, can be manufactured at a first location. This can be followed by transportation to the location at which the lens is intended to be inserted into a smartglasses frame, for example at an optician or at the abode of the user. Alternatively, a lens semifinished product can be manufactured at a first location and subsequently be sent to an optician or the like, where the replacement of the lens or the insertion of the lens is intended to take place. The optician can then process the lens semifinished product, for example work in an individual visual correction, and subsequently replace the lens or insert the latter into the smartglasses frame. It should be ensured that the lens can be looked through and provides a correct representation of the virtual image.

Lens shell and lens guide elements can preferably form a one-part component part, i.e. for example be manufactured monolithically, e.g. by means of injection molding. This allows simple and reproducible manufacture of the lens and can increase the accuracy of the positioning and alignment of the lens vis-à-vis the display. Alternatively, however, the lens guide elements can also be manufactured separately from the lens shell and can then be connected to the lens shell, with or without inserted optical waveguide.

Further disclosed is a pair of smartglasses. The pair of smartglasses comprises a smartglasses frame having a glasses frame designed to hold and position an interchangeable lens, and having a display connected to the glasses frame and designed to create a virtual image. The display can be connected in position-variable fashion to the glasses frame, e.g. by virtue of elastically deformable elements for forming a position-variable connection being arranged between the display and the glasses frame.

Moreover, the smartglasses comprise an interchangeable lens arranged in the smartglasses frame and having a lens shell and an optical waveguide designed to guide a light path for the virtual image. By preference, the lens shell can be designed to correct a visual error.

The smartglasses frame and/or the lens can be designed according to the description above. In this respect, reference is made to said explanations relating to the smartglasses frame and the lens, respectively. The advantages of the smartglasses frame and of the lens are correspondingly associated with the smartglasses.

The smartglasses are distinguished by the interchangeability of the lens or the lenses, with the result that adaptation to individual needs can be implemented easily while reusing the smartglasses frame. For example, there can be a non-destructive replacement of lenses with different properties regarding an individual visual correction, an adaptation of the eye box position to the individual pupil position, different UV protection levels and/or different tints. Additionally, if a lens is defective, it can easily be replaced in non-destructive fashion.

The interchangeability of the lens is made possible by virtue of the display and optionally further optical elements being connected to the smartglasses frame, e.g. being fastened to the glasses frame or glasses hinge. The display can be fastened freely in terms of position to the required extent, i.e. in position-variable fashion. For example, the lens can be connected to the display, optionally indirectly e.g. via a display holder, only by means of guidance by way of corresponding guide elements, e.g. the above-described glasses frame guide elements and lens guide elements.

In an alternative or in addition to such guidance, the lens and the display can be connected to one another by means of an easily removable connection, e.g. by means of a so-called peelable glue. For example, the adhesive can be designed to be detachable from the connection face in mechanical fashion, e.g. by peeling, in physical fashion by dissolution by means of a suitable solvent and/or in thermal fashion. In other words, the lens can be adhesively bonded to the smartglasses frame by means of an adhesive that is non-destructively removable, in relation at least to the smartglasses frame, preferably in relation to the smartglasses frame and the lens. For example, the smartglasses can be heated to a suitable temperature for the purpose of removing the adhesive.

Fastening the lens by means of an easily removable adhesive can enable secure and simple positioning and alignment of the lens with respect to the display.

Additionally disclosed is a kit of parts for obtaining a pair of smartglasses. To this end, the kit of parts comprises a smartglasses frame and at least one lens according to the description above. For a more detailed explanation regarding the smartglasses frame and the lens, reference is made to the statements given above; the advantages of the smartglasses frame and of the lens are correspondingly associated with the kit of parts.

Optionally, the kit of parts may comprise a guide having instructions detailing the replacement of the lens or the insertion of the lens. For example, such instructions may comprise an explanation regarding the method, described below, for assembling a pair of smartglasses.

Also disclosed is a method for assembling a pair of smartglasses. The method includes: providing a smartglasses frame having a glasses frame designed to hold and position an interchangeable lens, and having a display connected to the glasses frame and designed to create a virtual image, providing an interchangeable lens having a lens shell and an optical waveguide designed to guide a light path for the virtual image, positioning and aligning lens and display relative to one another, and fastening the lens in the smartglasses frame.

One of the pairs of smartglasses explained above can be assembled by means of the method. In this respect, reference is made to the explanations given above. The advantages of the smartglasses are correspondingly associated with the method.

Fastening the lens in the smartglasses frame can be implemented mechanically and/or by means of a non-destructively removable adhesive.

The smartglasses frame and the lens can be designed according to the description above. Then, lens and display can be aligned and positioned by means of the lens guide elements and the glasses frame guide elements.

### BRIEF DESCRIPTION OF THE DRAWINGS

Further features, properties and advantages of the present invention are explained in more detail below on the basis of exemplary embodiments with reference to the appended figures.

FIG. 1 shows an exploded illustration of an exemplary pair of smartglasses;

FIG. 2 shows a schematic illustration of an exemplary lens;

FIG. 3 shows a schematic illustration of an exemplary display holder;

FIG. 4 shows a schematic illustration of an exemplary one-piece smartglasses frame;

FIG. 5 shows an image to explain the insertion of a lens into a glasses frame; and

FIG. 6 shows a flowchart of an exemplary method for assembling a pair of smartglasses.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

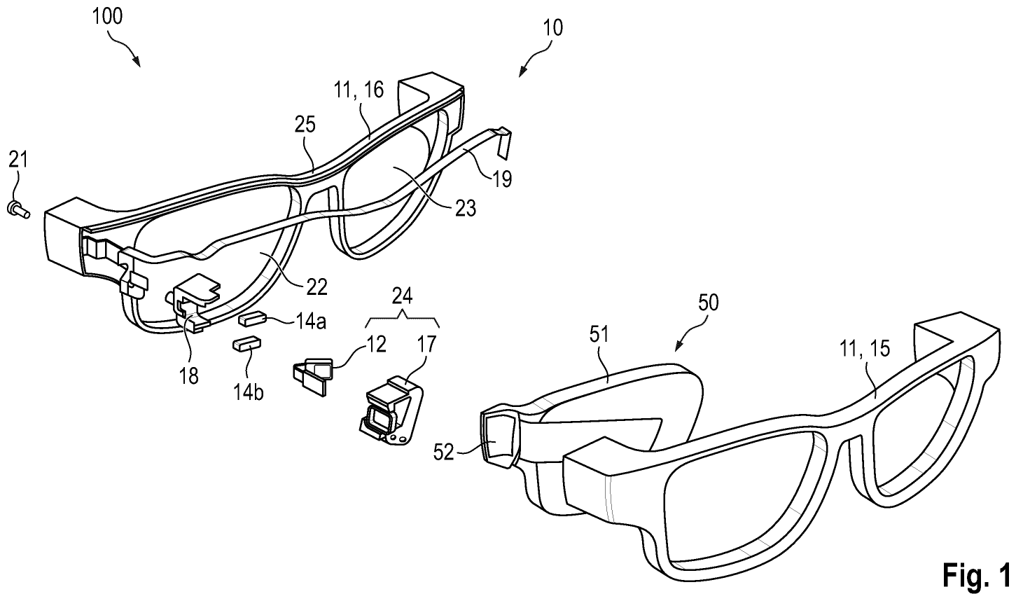

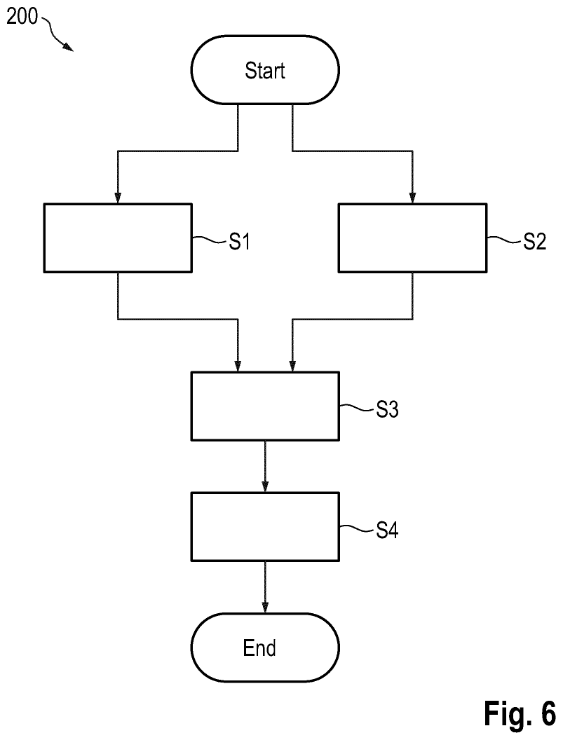

FIG. 1 shows a pair of smartglasses 100 having a smartglasses frame 10 and a lens 50 in a schematic exploded illustration. The assembly of such a pair of smartglasses 100 is explained in detail below with reference to FIG. 6.

The smartglasses frame 10 comprises a glasses frame 11 designed in two parts, with a front frame part 15 and a back frame part 16. The front frame part 15 and the back frame part 16 have complementary embodiments to one another and form the glasses frame 11 in the put-together state. The glasses frame 11 serves to hold and position the interchangeable lens 50. FIG. 1 only shows a single lens 50, which is or has been inserted into the right lens opening 22. A further interchangeable lens (not depicted), which has a correspondingly mirrored embodiment to the lens 50 shown, can be or have been inserted in the left lens opening 23. The frame regions surrounding the right and the left lens opening 22, 23 are connected to one another by means of a nosepiece 25.

A display 12 designed to create a virtual image is connected to the glasses frame 11. The display 12 comprises a plug for connection to the ribbon cable 19, which in turn is connected to a battery for power supply (not depicted), and a flexible printed circuit board. The display 12 is assembled in a display holder 17, e.g. pushed into appropriate guide elements and/or adhesively bonded to the display holder 17. Together, the display 12 and the display holder 17 form a display/display holder element 24.

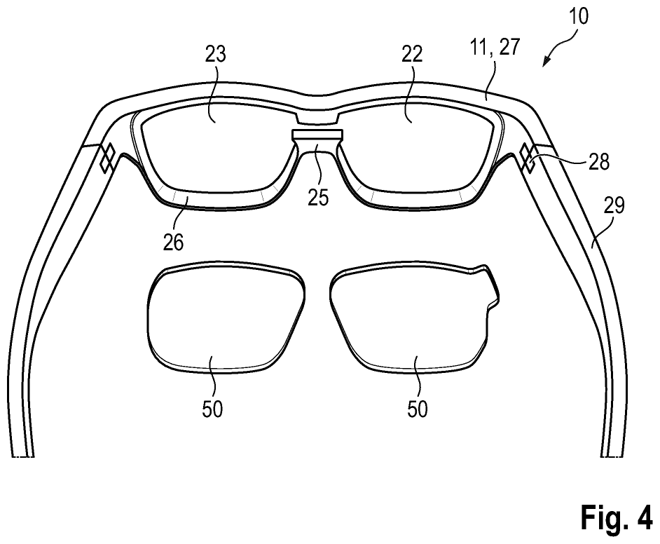

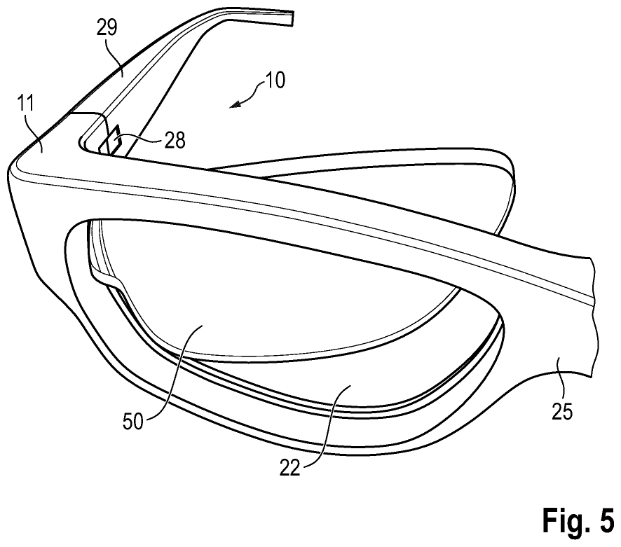

The display holder 17 is connected to the display holder mount 18 by means of click-in connection elements 20a, 20b (see FIG. 4). In an alternative to that or in addition, further connection elements can be provided for connecting display holder 17 and display holder mount 18. Two elastically deformable elements 14a, 14b, e.g. foam or elastomeric elements, are arranged between the display holder 17 and the display holder mount 18. The elastically deformable elements 14a, 14b allow a certain amount of movement of the display/display holder element 24 in the forward and backward direction, i.e. in the direction of the surroundings and in the direction of the face of the user when the smartglasses 100 are used.

The display holder mount 18 comprises two positioning pins (not depicted) which are or have been inserted in depressions (not depicted), provided to this end, in the back frame part 16. An additional screw-in connection (screw 21) can ensure that the display holder mount 18 is fastened to the back frame part 16.

In addition to the smartglasses frame 10, the smartglasses 100 comprise the interchangeable lens 50. The lens 50 is a monolithic smartglasses lens element comprising a lens shell 51 and an optical waveguide 52.

Optionally, the lens shell 51 can be designed for visual acuity correction and/or provide UV protection. In an alternative to that or in addition, the lens shell 51 can be tinted. Further individualizations are possible, e.g. an adaptation to the individual pupil position of the eye looking through the lens 50 having the optical waveguide 52. Moreover, the lens shell 51 comprises an input coupling region and/or an input coupling structure (not depicted separately) for input coupling the image created by the display 12 into the optical waveguide 52, and an output coupling structure (not depicted separately) for output coupling the image created by the display 12 from the optical waveguide 52 in the direction of the eye of the user. The optical waveguide 52 guides the light path of the virtual image from the display 12 to the output coupling structure in the lens shell 51. Optionally, the input coupling structure and/or the output coupling structure can be designed as elements separate from the lens shell 51 or as part of the optical waveguide 52.

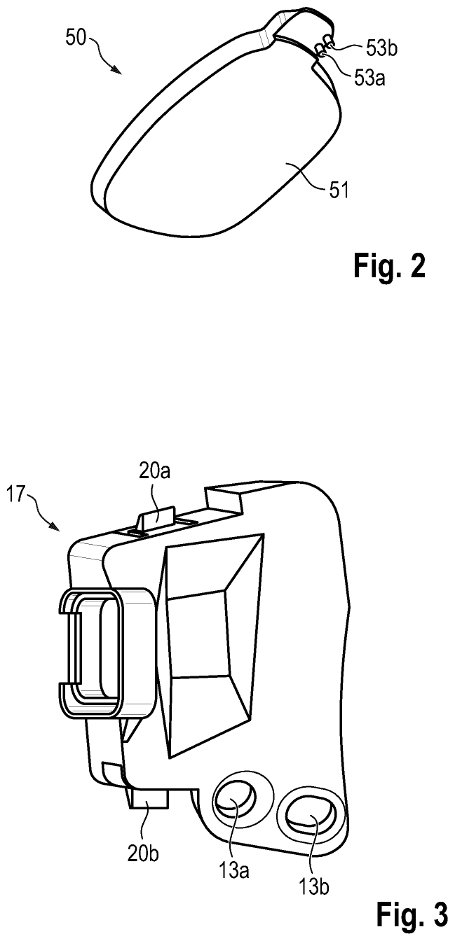

As shown in FIG. 2, the lens 50 comprises two lens guide elements 53a, 53b, designed as guiding cylinders in the exemplary embodiment. However, the invention is not restricted to a specific type of embodiment of the lens guide elements 53a, 53b and the glasses frame guide elements 13a, 13b, which are described below. The lens guide elements 53a, 53b are laterally on the lens 50 in the region where the optical waveguide 52 is arranged or is connected to the display holder 17. The lens shell 51 and the lens guide elements 53a, 53b form a one-part component part and e.g. can be manufactured together by means of injection molding.

The lens guide elements 53a, 53b serve to position and align the lens 50 in relation to the display 12. To this end, the lens guide elements 53a, 53b engage in glasses frame guide elements 13a, 13b of the smartglasses frame 10.

In the exemplary embodiment, the glasses frame guide elements 13a, 13b are designed in the form of depressions and, as shown in FIG. 3, arranged on the display holder 17. Moreover, the depressions in the glasses frame guide elements 13a, 13b open up like a funnel, i.e. they have an expanded diameter in the front region. This allows a simple insertion of the lens guide elements 53a, 53b because exact positioning of glasses frame guide elements 13a, 13b and lens guide elements 53a, 53b is not required. This increases the tolerance range when assembling or replacing the lens 50, and so this procedure can also be conducted by less specialized members of staff and optionally even by the user themselves.

Together with the lens guide elements 53a, 53b, the glasses frame guide elements 13a, 13b ensure secure and accurate positioning and alignment of display 12 and lens 50 with respect to one another, and so the virtual image created by the display 12 is reliably perceivable in the eye box.

At the same time, this allows the lens 50 to be replaced since the latter is not securely connected to the display 12; instead, the glasses frame guide elements 13a, 13b and the lens guide elements 53a, 53b can be non-destructively detached from one another when required. For example, a first lens 50 without visual correction can be replaced by a second lens 50 with visual correction.

In the assembled smartglasses 100, the lens 50 is inserted into the back frame part 16, with the glasses frame guide elements 13a, 13b and the lens guide elements 53a, 53b engaging in one another. In this case, the glasses frame guide elements 13a, 13b and the lens guide elements 53a, 53b are designed such that there is accurate positioning. The lens 50 is pressed against the display/display holder element 24 on account of the connection between the back frame part 16 and the front frame part 15. The display/display holder element 24 in turn is pressed against the display holder mount 18, whereby the lens 50 is held secure in its position.

The connection between the front and back frame part 15, 16 can be realized by hooks arranged on the two frame parts 15, 16 which hook into grooves arranged on the lower edge of the lens 50 (not depicted). Additionally, screw-in connections may be provided in the upper region of the glasses frame 11 (not depicted). It is self evident that alternative options for repeatedly detachably connecting the front and back frame part 15, 16 are possible.

Front and back frame element 15, 16 are separated from one another for a replacement or assembly of the lens 50. The lens 50 can subsequently be removed and replaced by another lens 50, or a lens 50 can be inserted. The two frame parts 15, 16 are reconnected to one another following the replacement or the insertion of the lens 50. This procedure does not require specialist tools; it is also possible to manage without an optical verification. The work steps can therefore also be performed by members of staff without a smartglasses specialism, for example by an optician, or optionally by the user themselves.

FIG. 4 shows a further exemplary smartglasses frame 10 having a one-part glasses frame 11 and two associated lenses 50. Moreover, two sidepieces 29 connected to the glasses frame 11 by means of hinges 28 are shown. The replacement or the assembly of the lenses 50 can be substantially implemented as described above with reference to FIGS. 1 to 3. As shown in FIG. 4, the lower frame part 26 and the upper frame part 27 can be detached from one another in the region of the nosepiece 25. In an alternative to that or in addition, detachment in the temporal region, i.e. on the outer sides of the glasses frame 11, would also be possible. Lenses 50 present can be removed after the glasses frame was opened. Subsequently, lenses 50 can be inserted into the opened glasses frame 11, optionally with play, with the lens guide elements 53a, 53b engaging in the glasses frame guide elements 13a, 13b. Subsequently, the lenses 50 are locked securely in position by connecting the upper and lower frame part 26, 27.

FIG. 5 shows a further exemplary smartglasses frame 10 having a one-part glasses frame 11 and an associated lens 50. In contrast to the one-part glasses frame 11 according to FIG. 4, the glasses frame according to FIG. 5 cannot be split. Together with the display holder mount 18, the display/display holder element 24 is inserted into the glasses frame 11 from behind and preferably fastened in position-variable fashion, e.g. screwed-in or adhesively bonded at one location and plugged onto guide elements, e.g. guide pins, of the glasses frame 11 at at least one further location. The lens 50 is placed against the glasses frame 11 from behind on the temporal side and then, under slight rotation, pressed into the glasses frame 11 in the nasal direction. The lens guide elements 53a, 53b are inserted into the glasses frame guide elements 13a, 13b during this rotating movement.

FIG. 6 shows an exemplary flowchart of a method 200 for assembling a pair of smartglasses 100. For example, the smartglasses 100 can be one of the smartglasses 100 explained above with reference to FIGS. 1 to 5.

Once the method has started, the smartglasses frame 10 with the glasses frame 11 and with the display 12 connected to the glasses frame 11 (step S1) and an interchangeable lens 50 with a lens shell 51 and an optical waveguide 52 (step S2) are provided.

Lens 50 and display 12 are positioned and aligned relative to one another in step S3. To this end, the lens guide elements 53a, 53b and the glasses frame guide elements 13a, 13b can be positioned and aligned relative to one another. The lens is fastened in the smartglasses frame 10 in step S4.

For example, the overall assembly process for the pair of smartglasses 100 shown in FIG. 1 can proceed as described below:
The display 12 is assembled on the display holder 17.
The display holder 17 is connected to the display holder mount 18 by means of click-in connection elements 20a, 20b. In the process, elastically deformable elements 14a, 14b are inserted between the display holder 17 and display holder mount 18.
The display 12 with the display holder 17 and display holder mount 18 is inserted into the back frame part 15 of the glasses frame 11 and fastened by means of a screw 21. In the process, the display/display holder element 24 is mounted in floating fashion, as described above.
The lens 50 is inserted into the back frame part 15. At the same time, the lens 50 and display/display holder element 24 are connected to one another via the glasses frame guide elements 13a, 13b arranged on the display holder 17 and the lens guide elements 53a, 53b.
The front and back frame parts 15, 16 are put together.
Putting the two frame parts 15, 16 together leads to the lens 50 being pressed against the display/display holder element 24. The display/display holder element 24 in turn is pressed against the display holder mount 18, whereby the lens 50 is held secure in its position. The front and back frame parts 15, 16 are connected by hooks arranged on the two frame parts 15, 16 which are hooked into grooves arranged on the lower edge of the lens 50. Additionally, there is a screw-in connection in the upper region of the glasses frame 11.

The described assembly procedure can be modified according to the specific conditions. For example, the sequence of the aforementioned method steps may differ, or additional method steps may be carried out. Further deviations can arise for reasons of assembly, e.g. if the precise connection, joining and/or guide elements are designed differently.

The figures are not necessarily accurate in every detail and to scale, and can be presented in enlarged or reduced form for the purpose of better clarity. For this reason, functional details disclosed here should not be understood to be limiting, but merely to be an illustrative basis that gives guidance to a person skilled in this technical field for using the present invention in various ways. Identical or similar elements are provided with identical reference signs in the figures, to the extent that this is expedient.

The expression “and/or” used here, when it is used in a series of two or more elements, means that any of the elements listed can be used alone, or any combination of two or more of the elements listed can be used. For example, the expression “UV protection and/or tinting” comprises the options of purely UV protection, purely tinting or UV protection and tinting in combination.

Directional terminology such as e.g. “back”, “front”, “bottom” and “top” relates to the orientation of a pair of smartglasses during intended operation, i.e. when worn by the user. Therefore, “back” means aligned in the direction of the user's face, “front” means aligned in the direction of the surroundings, i.e. opposite to the user's face, “bottom” means aligned in the direction of the ground and “top” means aligned in the direction of the sky.

Unless specified otherwise, connections can be realized in different ways, e.g.

as clip-in, adhesive or screwed-in connections.

### LIST OF REFERENCE SIGNS

10 Smartglasses frame
11 Glasses frame
12 Display
13a, 13b Glasses frame guide element
14a, 14b Elastically deformable element
15 Front frame part
16 Back frame part
17 Display holder
18 Display holder mount
19 Ribbon cable
20a, 20b Click-in connection element
21 Screw
22 Right lens opening
23 Left lens opening
24 Display/display holder element
25 Nosepiece
26 Lower frame part
27 Upper frame part
28 Hinge
29 Sidepiece
50 Lens
51 Lens shell
52 Optical waveguide
53a, 53b Lens guide elements
100 Smartglasses
200 Method
S1 Providing a smartglasses frame
S2 Providing an interchangeable lens
S3 Positioning and aligning lens and display relative to one another
S4 Fastening the lens in the smartglasses frame

1-13. (canceled)

14. A smartglasses frame for a pair of smartglasses, comprising:
a glasses frame configured to hold and position an interchangeable lens;
a display connected to the glasses frame and configured to create a virtual image; and
glasses frame guide elements configured to position and align the display in relation to the lens.

15. The smartglasses frame of claim 14, wherein the display is connected to the glasses frame in position-variable fashion.

16. The smartglasses frame of claim 15, wherein elastically deformable elements for forming a position-variable connection are arranged between the display and the glasses frame.

17. The smartglasses frame of claim 14, wherein the glasses frame comprises one or more parts.

18. An interchangeable lens for a pair of smartglasses, the lens comprising:
a lens shell;
an optical waveguide configured to guide a light path for a virtual image; and
lens guide elements configured to position and align the lens in relation to a display of a smartglasses frame.

19. The lens of claim 18, wherein the lens shell is configured to correct a visual error and/or specifies the position of the eye box.

20. The lens of claim 18, wherein the lens shell and the lens guide elements form a one-part component part.

21. A pair of smartglasses, comprising:
a smartglasses frame having a glasses frame configured to hold and position an interchangeable lens;
a display connected to the glasses frame and configured to create a virtual image, and
an interchangeable lens arranged in the smartglasses frame and comprising a lens shell and an optical waveguide designed to guide a light path for the virtual image.

22. The pair of smartglasses of claim 21, wherein the smartglasses frame comprises:
a glasses frame configured to hold and position an interchangeable lens;
a display connected to the glasses frame and configured to create a virtual image; and
glasses frame guide elements configured to position and align the display in relation to the lens.

23. The pair of smartglasses of claim 21, wherein the interchangeable lens comprises:
a lens shell;
an optical waveguide configured to guide a light path for a virtual image; and
lens guide elements configured to position and align the lens in relation to a display of a smartglasses frame.

24. The pair of smartglasses of claim 21, wherein the lens is adhesively bonded to the smartglasses frame via a non-destructively removable adhesive.

25. A kit of parts for obtaining a pair of smartglasses, the kit of parts comprising:
the smartglasses frame according to claim 14; and
the lens according to claim 18.

26. A method for assembling a pair of smartglasses, the method comprising:
providing a smartglasses frame having a glasses frame configured to hold and position an interchangeable lens, and a display connected to the glasses frame and configured to create a virtual image;
providing an interchangeable lens comprising a lens shell and an optical waveguide designed to guide a light path for the virtual image;
positioning and aligning lens and display relative to one another, and
fastening the lens in the smartglasses frame.

27. The method of claim 26, wherein the smartglasses frame is configured according to claim 14 and the lens is designed according to claim 18, and wherein the lens and the display are positioned and aligned relative to one another via lens guide elements and the glasses frame guide elements.
